(19) United States
(12) Patent Application Publication
(10) Pub. No.: US 2020/0324501 A1
(43) Pub. Date: Oct. 15, 2020

(54) BIOMASS PRESS WITH ULTRASONIC VIBRATION

(71) Applicant: KEITH HARRINGTON, Ogden (SU)

(72) Inventor: KEITH HARRINGTON, Ogden (SU)

(21) Appl. No.: 16/849,704

(22) Filed: Apr. 15, 2020

Related U.S. Application Data
(60) Provisional application No. 62/834,217, filed on Apr. 15, 2019.

(51) Int. Cl. B30B 11/02; B30B 9/04; B30B 15/00

(52) U.S. Cl. CPC B30B 11/022; B30B 9/047; B30B 15/26; B30B 15/0094; B30B 15/0041

(57) ABSTRACT

Apparatuses, systems, and methods are disclosed for extracting oil from biomass. An ultrasonic stack may be configured to produce ultrasonic vibrations at a first surface. An anvil may include a second surface disposed so that the first surface and the second surface define opposite sides of a space for receiving a biomass. A press coupled to the ultrasonic stack and the anvil may be configured to press the ultrasonic stack and the anvil together to compress the space and/or the biomass disposed in the space. The compressed space may be at least partially unenclosed to permit oil to move out of the biomass.

### CROSS-REFERENCES TO RELATED APPLICATIONS

This application claims the benefit of U.S. Provisional Patent Application No. 62/834,217 entitled “BIOMASS PRESS WITH ULTRASONIC VIBRATION” and filed on April 15, for Keith Harrington, which is incorporated herein by reference.

### FIELD

This invention relates to presses for extracting substances from biomass, and more particularly relates to biomass presses with ultrasonic vibration.

### BACKGROUND

A variety of fragrances, flavorings, medicines, and the like are derived from plants and other biological sources. Substances associated with fragrance, flavor, or pharmacological effects may be extracted from plant matter or other biological material using pressure, heat, solvents, or the like. However, excessive pressure and/or heat may damage the substances being extracted, changing the scent, flavor, effect or other properties of the substance in undesirable ways. Similarly, solvents remaining in the extracted substances may have undesirable characteristics.

### SUMMARY

Apparatuses are disclosed for extracting oil from biomass. In some embodiments, an ultrasonic stack is configured to produce ultrasonic vibrations at a first surface. In further embodiments, an anvil includes a second surface disposed so that the first surface and the second surface define opposite sides of a space for receiving a biomass. In some embodiments, a press coupled to the ultrasonic stack and the anvil is configured to press the ultrasonic stack and the anvil together to compress the space and/or the biomass disposed in the space. In further embodiments, the compressed space may be at least partially unenclosed to permit oil to move out of the biomass.

Methods are disclosed for extracting oil from biomass. A method, in one embodiment, includes providing an ultrasonic stack configured to produce ultrasonic vibrations at a first surface. In a further embodiment, a method includes providing an anvil that includes a second surface disposed so that the first surface and the second surface define opposite sides of a space for receiving a biomass. In some embodiments, a method includes providing a press coupled to the ultrasonic stack and the anvil. The press may be configured to press the ultrasonic stack and the anvil together to compress the space, and the compressed space may be at least partially unenclosed to permit oil to move out of the biomass. In certain embodiments, a method includes placing a biomass in the space. In some embodiments, a method includes using the ultrasonic stack and the press to apply pressure and ultrasonic vibrations to the biomass to extract the oil.

An apparatus, in another embodiment, includes means for producing ultrasonic vibrations at a first surface. In some embodiments, an apparatus includes means for contacting a biomass at a second surface disposed so that the first surface and the second surface define opposite sides of a space for receiving a biomass. In further embodiments, an apparatus includes means for compressing the space (and/or the biomass) between the first surface and the second surface. The compressed space may be at least partially unenclosed to permit oil to move out of the biomass.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view illustrating one embodiment of an apparatus for extracting oil from biomass;

FIG. 2 is a side view illustrating another embodiment of an apparatus for extracting oil from biomass;

FIG. 3 is a perspective view illustrating one embodiment of materials used for extracting oil from biomass;

FIG. 4 is a schematic flow chart diagram illustrating one embodiment of a method for extracting oil from biomass; and

FIG. 5 is a schematic flow chart diagram illustrating another embodiment of a method for extracting oil from biomass.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize that the embodiments may be practiced without one or more of the specific features or advantages of a particular embodiment. For example, the invention may be practiced without one or more of the specific details, or with other methods, components, materials, and so forth. In other instances, well-known structures, materials, or operations are not shown or described in detail to avoid obscuring aspects of the invention. Additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

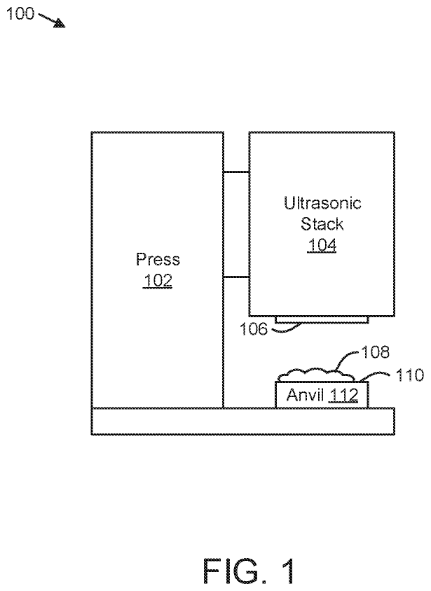

FIG. 1 depicts one embodiment of an apparatus 100 for extracting oil from biomass 108. In the depicted embodiment, the apparatus 100 includes an ultrasonic stack 104, an anvil 112, and a press 102.

In various embodiments, a biomass 108 may be placed in a space between the ultrasonic stack 104 and the anvil 112. In further embodiments, the press 102 may press the ultrasonic stack 104 and the anvil 112 together to compress the space, and the biomass 108 in the space. The ultrasonic stack 104 may be used to produce ultrasonic vibrations, which cause oils in the biomass 108 to heat up and flow. The compressed space between the ultrasonic stack 104 and the anvil 112 may be at least partially unenclosed, permitting oil to move or flow out of the biomass 108.

In various embodiments, ultrasonic vibrations may cause molecules in the biomass 108 to move past each other, resulting both in heating (as molecular-level motion increases) and in improved fluid flow. For example, an oil, wax, rosin, or the like may be more viscous and less prone to flow when heated to a particular temperature by non-ultrasonic means (e.g., by an electric heater), but may flow more readily when an apparatus 100 applies ultrasonic vibrations to heat the same substance to the same temperature. Thus, in various embodiments, an apparatus 100 that uses pressure and ultrasonic vibrations to extract oil from biomass 108 may provide faster, lower pressure, and/or lower temperature extraction of oil from the biomass 108, than when using a non-ultrasonic press, thus avoiding the deterioration or loss of desirable properties in the oil that might occur with higher temperatures, pressures, or times.

Biomass 108, in various embodiments, may be material obtained from biological organisms, such as plants, animals, fungi, microorganisms, or the like. In certain embodiments, biomass 108 may be from plants, and may include leaves, flowers, stems, roots, seeds, or the like. For example, an apparatus 100 may be used to extract oils used in flavorings, fragrances, medicines, or the like, from biomass 108 such as mint leaves, lavender flowers, citrus peel, balsam tree sap, cinnamon bark, juniper berries, valerian root, flax seed, cedar wood, or the like. Similarly, an apparatus 100 may be used to extract oils used medically and/or recreationally for pharmacological effects from biomass 108 from cannabis plants, where the biomass 108 includes buds, trichomes, or the like. An apparatus 100 may similarly be used to extract oil from various other or further types of biomass 108.

The terms “oil” and “oils” as used herein, refer to any lipophilic and/or hydrophobic substance present in the biomass 108, which may be extracted from the biomass 108 using pressure, heat, ultrasonic vibrations, or the like. Although terms such as “vegetable oil” in general use may refer specifically to plant-derived fats that are liquid at room temperature, the term “oil” is used more broadly herein to refer to lipophilic and/or hydrophobic substances. Substances referred to herein as “oil” or “oils” may include liquid fats, solid fats, resins, oleoresins, waxes, hydrocarbons, terpenes, terpenoids, carboxylic acids, or the like, and/or mixtures including one or more such substances. Various other or further lipophilic and/or hydrophobic substance may also be referred to as “oil” or “oils.”

The ultrasonic stack 104, in the depicted embodiment, is configured to produce ultrasonic vibrations at a first surface 106. Ultrasonic vibrations, in various embodiments, may be mechanical vibrations with frequencies at or above 15 kilohertz (kHz). Such vibrations may be physically similar to sound, but inaudible to (many) humans. Vibrations at some ultrasonic frequencies may be audible to at least some humans but may nevertheless be referred to as ultrasonic. Similarly, vibrations at some frequencies near but not above 15 kHz (e.g., at 14 kHz) may be produced by an ultrasonic stack 104 and may still be referred to as ultrasonic. Other ultrasonic vibrations may be at frequencies above 15 kHz (e.g., 20 kHz or higher, into hundreds of kilohertz, or into the megahertz or gigahertz ranges) and may be well outside the range of typical human perception.

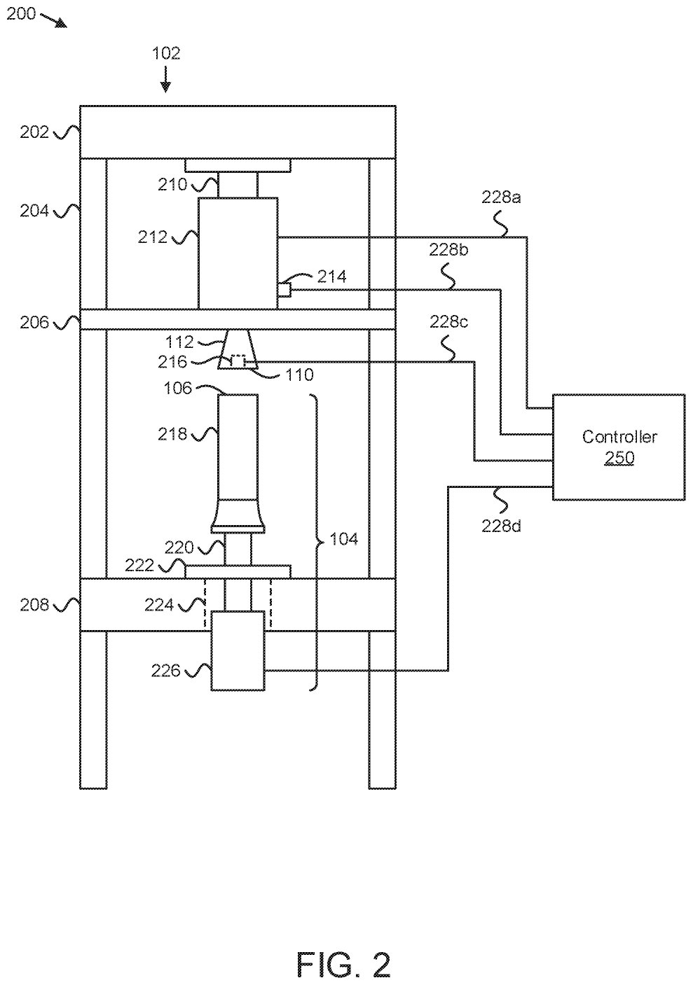

In various embodiments, an ultrasonic stack 104 may be, or may include, any component or set of components capable of producing ultrasonic vibrations, amplifying or reducing the magnitude of ultrasonic vibrations, and/or transmitting the ultrasonic vibrations to a first surface 106. For example, in various embodiments, an ultrasonic stack 104 may include components such as a transducer that produces ultrasonic vibrations in response to an applied electrical voltage, a horn or sonotrode that transmits the vibrations to the biomass 108, a booster that couples the transducer to the horn. An ultrasonic stack 104 including a transducer, a booster, and a horn is described in more detail below with reference to FIG. 2. In some embodiments, an ultrasonic stack 104 may include additional components, and/or may omit components described above. For example, a power supply that produces an ultrasonic-frequency electrical voltage used by the transducer may be included in the ultrasonic stack 104, or may be a separate component electrically coupled to the ultrasonic stack 104. Similarly, in one embodiment, a transducer may be coupled to a horn directly, without a booster. Various other or further configurations of an ultrasonic stack 104 are possible.

As described above, in the depicted embodiment, the ultrasonic stack 104 produces ultrasonic vibrations at the first surface 106. “Producing” ultrasonic vibrations at a surface, in various embodiments, may refer to actually creating the vibrations at that surface, or to transmitting or conducting vibrations that are created elsewhere to a surface. The first surface 106, in various embodiments, may be any surface where ultrasonic vibrations are produced. In further embodiments, the first surface 106 may be a surface that contacts or applies pressure to the biomass 108 when the apparatus 100 is used to extract oil from the biomass 108. For example, where the ultrasonic stack 104 includes a horn, the first surface 106 may be a surface of a horn, and the horn may contact or apply pressure to the biomass 108 when the apparatus 100 is used.

The anvil 112, in the depicted embodiment, includes a second surface 110. In various embodiments, the second surface 110 may be a surface other than the first surface 106, and may also contact or apply pressure to the biomass 108 when the apparatus 100 is used to extract oil from the biomass 108. The second surface 110, in further embodiments, is disposed so that the first surface 106 and the second surface 110 define opposite sides of a space for receiving the biomass 108. For example, in the depicted embodiment, biomass 108 may be received in a space between the ultrasonic stack 104 and the anvil 112, where the first surface 106 is at the top of the space and the second surface 110 is at the bottom of the space. In another embodiment, the ultrasonic stack 104 may be below the anvil 112, so that the first surface 106 defines the bottom of the space for receiving biomass 108, and the second surface 110 defines the top. In another embodiment, the first surface 106 and the second surface 110 may be at horizontally opposite sides of a space (e.g., the biomass 108 may be pressed from the sides while being supported on another surface).

Additionally, although the first surface 106 and the second surface 110 are depicted as flat surfaces in FIG. 1, surfaces that define opposite sides of a space for receiving biomass 108 may be curved or otherwise non-flat surfaces. For example, in one embodiment, the first surface 106 may be convex, and the second surface 110 may be concave. In another embodiment, the anvil 112 may be a rotating drum for continuous feeding of biomass 108 into the apparatus 100, and the second surface 110 may be the cylindrical surface of the drum. Various other or further configurations of a first surface 106 and a second surface 110 to define a space for receiving a biomass 108 are possible.

The anvil 112, in various embodiments, is a component that includes the second surface 110 described above. In one embodiment, an anvil 112 may be a baseplate or fixture for holding the biomass 108. In certain embodiments, an anvil 112 may be a “bottom mould” configured for ultrasonic applications (regardless of whether it is positioned above, below, or to the side of the first surface 106). For example, the material, shape, size, and/or other aspects of the anvil 112 may be selected to focus or concentrate ultrasonic energy in the biomass 108, to reflect more ultrasonic energy into the biomass 108 than it transmits to the opposite side of the anvil 112, or the like. Various other or further configurations of an anvil 112 are possible

The press 102, in the depicted embodiment, is coupled to the ultrasonic stack 104 and the anvil 112, and is configured to press the ultrasonic stack 104 and the anvil 112 together. Pressing the ultrasonic stack 104 and the anvil 112 together may include moving the ultrasonic stack 104 toward a stationary anvil 112, moving the anvil 112 toward a stationary ultrasonic stack 104, moving both the ultrasonic stack 104 and the anvil 112, or the like. Additionally, pressing the ultrasonic stack 104 and the anvil 112 together may include increasing the pressure on the biomass 108 (or any other substance in the space between the first surface 106 and the second surface 110), even if motion of the ultrasonic stack 104 and the anvil 112 is minimal.

A press 102, in various embodiments, may include any component or set of components capable of pressing the ultrasonic stack 104 and the anvil 112 together. In certain embodiments, a press 102 may be an arbor press, a screw press, a hydraulic press, a pneumatic press, or the like. The ultrasonic stack 104 and the anvil 112 may be coupled to the press 102 in a variety of ways. For example, the anvil 112 may be integrally formed as part of the press 102, non-detachably fastened to the press 102, removably fastened to the press 102, simply placed on the press 102 without fasteners, or the like Various other or further types of press 102 and of ways to an ultrasonic stack 104 and/or an anvil 112 to a press 102 may be included in an apparatus 100.

In various embodiments, using a press 102 to press the ultrasonic stack 104 and the anvil 112 together compresses the space between the first surface 106 and the second surface 110, thus also compressing a biomass 108 (or any other substance) disposed in the space. In certain embodiments, the compressed space, when the press 102 is used to press the ultrasonic stack 104 and the anvil 112 together, is at least partially unenclosed to permit oil to move or flow out of the biomass 108. An at least partially unenclosed space, in various embodiments, may be any space that is not fully enclosed. A fully enclosed space may be a space without openings, that fully surrounds the biomass 108. Compressing a fully enclosed space may impart the shape of the compressed space to the biomass 108. For example, a fully enclosed space may be a mold for forming the biomass 108 into a shape. However, a fully enclosed space may confine the oil with the biomass 108, thus failing to effectively extract or separate the oil.

Conversely, an at least partially unenclosed space may include openings allowing the oil to move out of the biomass 108. For example, in the depicted embodiment, the space between the first surface 106 and the second surface 110 has open sides, allowing oil to flow to the side when the biomass 108 is compressed. In another embodiment, an at least partially unenclosed space may be surrounded by side components to retain the biomass 108 between the anvil 112 and the ultrasonic stack 104, but may include openings in the side components, the anvil 112, or the like, allowing oil to flow out of the biomass 108 through the openings. In another embodiment, a partially unenclosed space may be similar to a fully enclosed space but with holes or openings in an upper surface, a lower surface, one or more side surfaces, or the like, that permit oil to move out of the biomass. In some embodiments, holes may be sized to permit liquid (or liquified) oils to pass through the holes, but to retain larger solid particles of biomass in the space. For example, in one embodiment, the sides of the space may be surrounded by a mesh or screen so that the solid parts of the mesh enclose and retain larger particles of biomass as if they were in a fully enclosed space, while the holes in the mesh or screen permit oils to flow out of the space.

FIG. 2 depicts another embodiment of an apparatus 200 for extracting oil from biomass 108. The apparatus 200, in the depicted embodiment, may be substantially similar to the apparatus 100 described above with reference to FIG. 1, including an ultrasonic stack 104, an anvil 112, and a press 102, which may be substantially as described above, and which are described in further detail below. In the depicted embodiment, the apparatus 200 includes a pressure sensor 214, a temperature sensor 216, and a controller 250, which are described below. In some embodiments, an apparatus 200 may omit certain components described herein, or may include additional components or variations of components described herein. For example, although the apparatus 200 in the depicted embodiment includes a pressure sensor 214 and a temperature sensor 216 coupled to a controller 250, an apparatus 200 in another embodiment may omit either the temperature sensor 216 or the pressure sensor 214. Conversely, in another embodiment, an apparatus 200 may include multiple temperature sensors 216 to measure temperature at different points. Or, although the press 102 is described below as an H-frame press, a press 102 in another embodiment may have another shape.

In the depicted embodiment, the press 102 is an H-frame press, which includes two vertical legs 204, an upper crossbar 202, lower crossbar 208, and a moving crossbar 206. The upper crossbar 202 is connected to the tops of the vertical legs 204, and the lower crossbar 208 is connected to both legs 204 further down. Further components such as broad or long feet for stabilizing the legs 204 are not shown, but may be included in a press 102 in some embodiments. The moving crossbar 206 extends across the press 102 between the legs 204, and is configured to slide up and down relative to the legs 204. In the depicted embodiment, the press 102 includes a ram, which may be a hydraulic ram or a pneumatic ram. The ram includes a cylinder 212 with a piston that is moved by pressurized air or hydraulic fluid, and a piston rod 210 that moves into or out of the cylinder 212 based on the position of the piston. In the depicted embodiment, the ram is coupled between the upper crossbar 202 and the moving crossbar 206, so that the moving crossbar 206 is pushed down when the piston rod 210 is extended from the cylinder 212, and pulled up when the piston rod 210 is retracted into the cylinder 212. In another embodiment, the ram may be coupled between the lower crossbar 208 and the moving crossbar 206, so that the moving crossbar 206 is pushed up when the piston rod 210 is extended from the cylinder 212, and lowered when the piston rod 210 is retracted into the cylinder 212. Similarly, although the piston rod 210 extends from the top of the cylinder 212 in the depicted embodiment, the piston rod 210 may extend from the bottom of the cylinder 212 in another embodiment.

The anvil 112, in the depicted embodiment, is coupled to the moving crossbar 206, with the second surface 110 facing down, while the ultrasonic stack 104 is coupled to the lower crossbar 208, with the first surface 106 facing up. In various embodiments, the ram is coupled to one of the stationary crossbars (e.g., the upper crossbar 202 or the lower crossbar 208) and to the moving crossbar 206, to move the moving crossbar 206. The anvil 112 (or the ultrasonic stack 104) is coupled to the moving crossbar 206 opposite the ram, and the ultrasonic stack 104 (or the anvil 112) is coupled to the remaining stationary crossbar (e.g., the lower crossbar 208 if the ram is coupled to the upper crossbar 202, or the upper crossbar 202 if the ram is coupled to the lower crossbar 208). For example, in the depicted embodiment, the ultrasonic stack 104 extends through a hole 224 (represented by dashed lines) in the lower crossbar 208, and is mounted to the lower crossbar 208.

The anvil 112, in the depicted embodiment, is shaped as a section or frustum of a cone, so that the second surface 110 is circular. The shape of the anvil 112, in the depicted embodiment, concentrates ultrasonic vibrations into the biomass 108 (not shown in FIG. 2).

The ultrasonic stack 104, in the depicted embodiment, includes a transducer 226, a booster 220, and a horn 218. The first surface 106, in the depicted embodiment, is a surface at one end of the horn 218. The transducer 226 or converter, in various embodiments, may produce ultrasonic vibrations. Various types of ultrasonic transducer 226, such as piezoelectric transducers or capacitive transducers, may be used in an apparatus 200. In one embodiment, the transducer 226 is configured to produce the ultrasonic vibrations with a power in a range from 2500 to 3500 watts (W). For example, in one embodiment, the transducer 226 may be configured to use 3000 watts of power. Power for a transducer 226 may refer to power consumed (e.g., as supplied by an electrical power supply) or to power in the ultrasonic vibrations (e.g., power supplied, minus power wasted as heat, noise, and the like). In certain embodiments, the transducer 226 is configured to produce the ultrasonic vibrations with a frequency in a range from 15 to 120 kHz. In a further embodiment, a transducer 226 is configured to produce the ultrasonic vibrations with a frequency in a range from 20 to 80 kHz. In one embodiment, the ultrasonic vibrations may be at a frequency of approximately 20 kHz (e.g., in a range from 15 to 15 kHz).

The booster 220 or amplitude transformer, in the depicted embodiment, may transmit ultrasonic vibrations from the transducer 226 to the horn 218. For example, in some embodiments, the booster 220 may be a half-wavelength long (based on the frequency of the ultrasonic vibrations and the speed of sound in the booster 220) with vibration antinodes at both ends and a stationary node in the middle. In the depicted embodiment, the booster 220 includes a mounting ring 222 at a midpoint, which may be used to couple the ultrasonic stack 104 to the press 102. For example, in the depicted embodiment, the mounting ring 222 is fastened to the lower crossbar 208 (e.g., so that the booster 220 extends into the hole 224 from a mounting ring 222 with a greater diameter than the hole 224). Additionally, in certain embodiments, the booster 220 may increase the magnitude (e.g., measured by displacement) of the ultrasonic vibrations produced by the transducer 226. In, another embodiment, however, a booster 220 may reduce the amplitude of vibrations, or may have unitary gain, and may still be referred to as a booster 220.

The horn 218 or sonotrode, in the depicted embodiment, is coupled to the booster 220, and transmits ultrasonic vibrations from the booster 220 into the biomass 108 via the first surface 106. In certain embodiments, the horn 218 may be shaped to further amplify the ultrasonic vibrations.

In some embodiments, efficient extraction of oil from biomass 108 may use considerably more force or pressure than other ultrasonic applications such as ultrasonic plastic welding. Thus, in some embodiments, the booster 220 and the horn 218 may be configured to withstand at least 1500 pounds of force from the press 102 without being damaged. Damage may include permanent deformation, bending, buckling, breaking, or the like, for the booster 220, the horn 218, the mounting ring 222, or other components. In various further embodiments, the booster 220 and the horn 218 may be configured or rated to withstand greater forces of 2000 pounds, 6000 pounds, 10,000 pounds or more. The anvil 112 may be similarly configured to withstand high forces.

Configuring components such as a booster 220, a horn 218, a mounting ring 222, or the like to withstand force may include steps such as selecting a material such as a steel or titanium alloy, modeling the effects of force on the material (e.g., using finite element analysis), selecting or modifying dimensions such as a width of a booster 220 or horn 218, or a thickness of a mounting ring 222 based on the modeling, so that the component does not buckle (or otherwise permanently deform) under a threshold level of force. With certain dimensions selected or modified to withstand force, further dimensions such as heights of a booster 220 or horn 218 may be also be selected or modified based on the modeling to provide resonance to ultrasonic vibrations at a frequency produced by the transducer. Dimensions of components in the ultrasonic stack 104 may be iteratively modeled and modified to transmit or amplify ultrasonic forces while withstanding high forces from the press 102. Various other or further ways of configuring ultrasonic components to withstand high forces may also be used.

The first surface 106 and the second surface 110, in the depicted embodiment, are flat surfaces of equal size. Surfaces that are not substantially curved may be referred to as flat despite some surface roughness or deformation. Similarly, surfaces may be approximately equal, equal to within 10 percent, or the like, and may still be referred to as surfaces of equal size. In certain embodiments, flat, equal-sized surfaces may press evenly across biomass 108 disposed in the space between the surfaces.

In some embodiments, a silicone coating may be applied to the first surface 106 and/or the second surface 110. In some embodiments, silicone or other coatings used for high-pressure processing of food may facilitate removal of biomass 108 and/or oil from the surfaces 106, 110, without contamination of the oil or biomass 108. In certain embodiments, rather than (or in addition to) coating the surfaces 106, 110, biomass 108 may be placed between removable films or mats prior to being placed between the surfaces 106, 110.

In certain embodiments, the first surface 106 and the second surface 110 both have areas in a range from 50 to 150 square centimeters. In further embodiments, the first surface 106 and the second surface 110 may both have areas in a range from 80 to 120 square centimeters. In the depicted embodiment, the first surface 106 and the second surface 110 both have areas of 100 square centimeters.

In some embodiments, the pressure in the biomass 108, or in the space between the first surface 106 and the second surface 110 space when the ultrasonic stack 104 and the anvil 112 are pressed together may be in a range from 800 to 2200 pounds per square inch. For example, a pressure may be approximately 1000 pounds per square inch, approximately 2000 pounds per square inch, or the like.

A controller 250, in the depicted embodiment, is coupled to the ultrasonic stack 104 and the press 102 to control the ultrasonic vibrations and a pressure in the space between the surfaces 106, 110. The controller 250, in various embodiments may include general purpose computing hardware such as a processor, which executes code stored on a computer-readable medium to control the ultrasonic vibrations and the pressure, and/or may include specialized hardware such as a power supply for generating high-voltage, ultrasonic frequency electrical signals. The controller 250 may be coupled to other components including the press 102 and the ultrasonic stack 104 via lines 228, which may be different types of communicative couplings and/or power couplings to couple the controller 250 to different components. For example, the controller 250 may be coupled to the ultrasonic stack 104 via a high-voltage power line 228d, to a temperature sensor 216 and a pressure sensor 214 via lower-voltage signal lines 228b-c, and may use a compressed air line 228a to actuate the hydraulic or pneumatic cylinder 212 (e.g., the controller 250 may include or be coupled to an electrical switch or valve for controlling air pressure in the line 228a, and the air line 228a may be coupled directly to a pneumatic cylinder 212 or to an air-powered actuator for a hydraulic cylinder 212).

The pressure sensor 214, in the depicted embodiment, may determine a pressure in the space between surfaces 106, 110 (e.g., in a biomass disposed in the space). The pressure sensor 214 may be a sensor disposed between the first surface 106 and the second surface 110 to directly measure the pressure in the space, or may be disposed elsewhere to indirectly measure the pressure in the space. For example, in the depicted embodiment, the pressure sensor 214 is disposed in the cylinder 212 to measure hydraulic or pneumatic pressure in the cylinder 212, corresponding to a pressure in the space, or in the biomass disposed in the space. In another embodiment a pressure sensor 214 may be disposed in another location, such as between the ram and the anvil 112. Various types of pressure sensors 214 may sense force for a known area, or may sense some other quantity that corresponds to pressure, such as density of air molecules in a pneumatic cylinder. In the depicted embodiment, the pressure sensor 214 is in communication with the controller 250 via a line 228b.

The controller 250, in the depicted embodiment, is configured to control the press 102 to further compress the space (and the biomass in the space) in response to detecting a pressure decrease via the pressure sensor 214. A pressure decrease, in some embodiments, may indicate that the biomass 108 is deforming as oil moves out of the biomass 108. Further compressing the space and/or the biomass may restore or maintain the pressure so that oil continues to flow out of the biomass 108. In certain embodiments, the controller 250 may maintain the pressure below a pressure threshold. A pressure threshold may be a limit for the pressure and may be configured based on other components. For example, high pressures may cause deterioration in the oil, or may damage components such as the horn 218, and a pressure threshold may be selected to avoid deterioration or damage.

The temperature sensor 216, in the depicted embodiment, may determine a temperature in the space between surfaces 106, 110 (e.g., in a biomass disposed in the space). The temperature sensor 216 may be a sensor disposed between the first surface 106 and the second surface 110 to directly measure the temperaturein the space and/or the biomass, or may be disposed elsewhere, such as in the horn 218 or in the anvil 112 to indirectly measure the temperature in the space. For example, in the depicted embodiment, the temperature sensor 216 is disposed in the anvil 112. A temperature sensor 216 may be a thermocouple, a thermistor, a semiconductor-based sensor, or the like. In the depicted embodiment, the temperature sensor 216 is in communication with the controller 250 via a line 228c.

The controller 250, in the depicted embodiment, is configured to control the ultrasonic stack 104 to heat the biomass 108 above a first temperature threshold and to maintain the temperature below a second temperature threshold. A first temperature threshold may be a low temperature threshold selected so that oil flows out of the biomass 108 at temperatures around or above the first temperature threshold. In some embodiments, a first temperature threshold may be selected so that a desirable chemical change, such as decarboxylation of cannabis, occurs at temperatures around or above the first temperature threshold. A second temperature threshold may be a high temperature threshold selected so that damage to the oil, such as chemical deterioration causing undesirable flavors, aromas, or other properties, is avoided or reduced at temperatures below the second temperature threshold.

In certain embodiments, the temperature thresholds may be based on a target temperature for heating the biomass 108. For example, in the depicted embodiment, the target temperature may be 100 degrees Celsius, so the first temperature threshold may be greater than or equal to 80 degrees Celsius and the second temperature threshold may be less than or equal to 120 degrees Celsius.

In various embodiments, ultrasonic vibrations may cause heating of the biomass 108. Thus, in further embodiments, the controller 250 may heat the biomass 108 to at least a first threshold and maintain the temperature below a second threshold by controlling the ultrasonic stack 104. In one embodiment, the controller 250 may control the ultrasonic stack 104 to change or maintain temperature by controlling or modifying a power level supplied to the transducer 226. In another embodiment, the controller 250 may control the ultrasonic stack 104 to change or maintain temperature by changing a duty cycle for the ultrasonic stack 104. A duty cycle may be a ratio of time on to time off. For example, an ultrasonic stack 104 operated with a 20% duty cycle may produce ultrasonic vibrations in cycles with for 200 milliseconds (ms) on, and 800 ms off. Increasing the duty cycle (e.g., to 50% or 500 ms on followed by 500 ms off) may increase the temperature, and decreasing the duty cycle (e.g., to 10% or 100 ms on followed by 900 ms off) may decrease the temperature.

In one embodiment, a duty cycle for the ultrasonic stack 104 (e.g., as controlled by the controller 250) may be preconfigured based on a desired temperature for the biomass 108. For example, a manufacturer or user may determine what duty cycle produces a desired temperature, and preconfigure the controller 250 to control the ultrasonic stack 104 with that duty cycle. In certain embodiments, the preconfigured duty cycle may heat the biomass 108 to the desired temperature without non-ultrasonic heating. For example, an apparatus 200 may heat a biomass 108 using the ultrasonic stack 104, without the use of resistive heaters, combustion heaters, heat pumps, or the like.

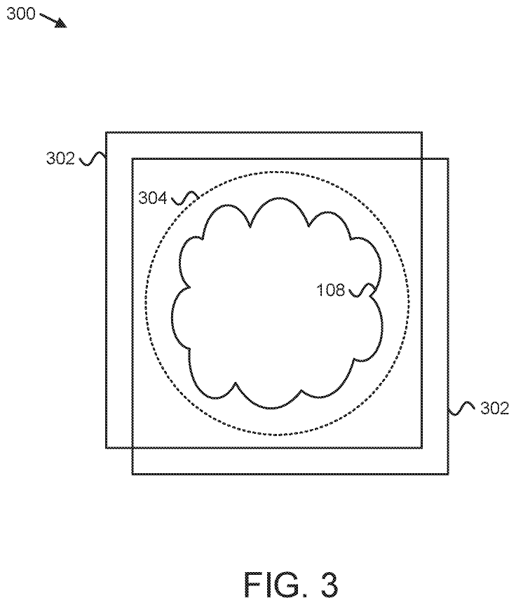

FIG. 3 is a perspective view illustrating one embodiment of materials used for extracting oil from biomass 108. In certain embodiments, a biomass 108 may be placed between removable films or mats 302 for use in an apparatus 100, 200. Removable films or mats 302 may include silicone mats, parchment paper, nylon mesh fabric, polyester mesh fabric, or the like. Under pressure and ultrasonic vibrations from the apparatus 100, 200, oil 304 may flow out of the biomass 108 between the removable films or mats 302. In one embodiment, the removable films or mats 302 may include non-porous or slick material so that the oil 304 is captured between (and removable from) the films or mats 302. In another embodiment, the removable films or mats 302 may include porous material such as fabric mesh or paper so that the biomass 108 can be removed from between the films or mats 302, while the oil 304 remains captured in pores of the films or mats 302. Films or mats 302 for capturing oil 304 may be provided as squares, circles, continuous sheets, bags (e.g., similar to tea bags) or the like.

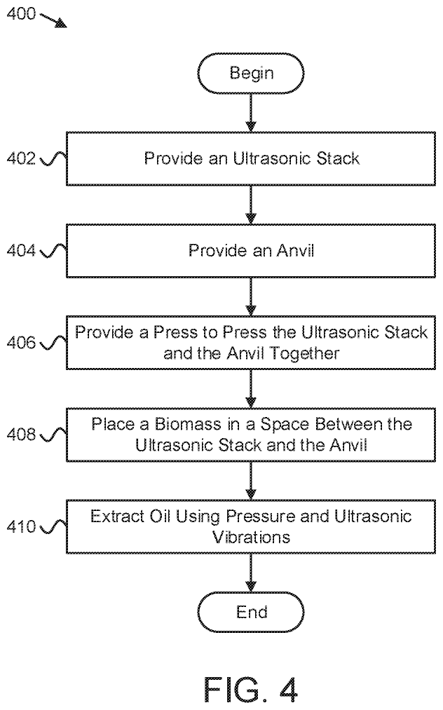

FIG. 4 is a schematic flow chart diagram illustrating one embodiment of a method 400 for extracting oil from biomass 108. The method 400 begins. An ultrasonic stack 104 is provided 402. The ultrasonic stack 104 is configured to produce ultrasonic vibrations at a first surface 106. An anvil 112 is provided 404. The anvil 112 includes a second surface 110 disposed such that the first surface 106 and the second surface 110 define opposite sides of a space for receiving a biomass 108. A press 102 is provided 406. The press 102 is configured to press the ultrasonic stack 104 and the anvil 112 together to compress the space. The compressed space is at least partially unenclosed to permit oil to move out of the biomass 108. A biomass 108 is placed 408 in the space between the ultrasonic stack 104 and the anvil 112. Oil is extracted 410 by using the ultrasonic stack 104 and the press 102 to apply pressure and ultrasonic vibrations to the biomass 108, and the method 400 ends.

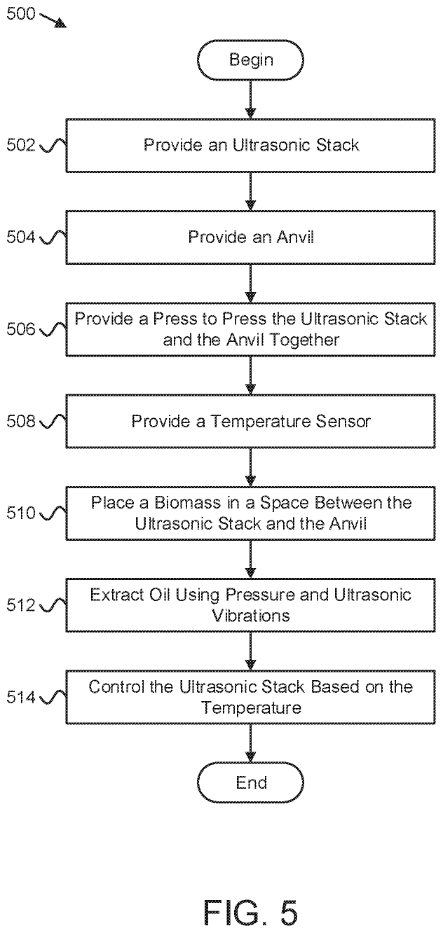

FIG. 5 is a schematic flow chart diagram illustrating another embodiment of a method 500 for extracting oil from biomass 108. The method 500 begins. An ultrasonic stack 104 is provided 502. The ultrasonic stack 104 is configured to produce ultrasonic vibrations at a first surface 106. An anvil 112 is provided 504. The anvil 112 includes a second surface 110 disposed such that the first surface 106 and the second surface 110 define opposite sides of a space for receiving a biomass 108. A press 102 is provided 506. The press 102 is configured to press the ultrasonic stack 104 and the anvil 112 together to compress the space. The compressed space is at least partially unenclosed to permit oil to move out of the biomass 108. A temperature sensor 216 is provided 508 for determining a temperature of the biomass 108. A biomass 108 is placed 510 in the space between the ultrasonic stack 104 and the anvil 112. Oil is extracted 512 by using the ultrasonic stack 104 and the press 102 to apply pressure and ultrasonic vibrations to the biomass 108. A controller 250 controls 514 the ultrasonic stack 104 based on the temperature from the temperature sensor 216, to heat the biomass 108 above a first temperature threshold and to maintain the temperature below a second temperature threshold, and the method 500 ends.

In various embodiments, a means for producing ultrasonic vibrations as a first surface may include an ultrasonic stack 104, transducer 226, a booster 220, a horn 218, and/or a controller 250. Other embodiments may include similar or equivalent means for producing ultrasonic vibrations.

In various embodiments, a means for contacting a biomass at a second surface may include an anvil 112, a stationary anvil with a flat surface, a rotating drum with a cylindrical surface, and/or an ultrasonic “bottom mould.” Other embodiments may include similar or equivalent means for contacting a biomass at a second surface.

In various embodiments, a means for compressing the space (and/or the biomass) between the first surface and the second surface may include a press 102, an arbor press, a screw press, an H-frame press, a hydraulic press, a pneumatic press, a controller 250, a compressed air line, an electrically operated switch or valve, an air-powered actuator for a hydraulic cylinder, or the like. Other embodiments may include similar or equivalent means for compressing the space and/or the biomass.

In various embodiments, a means for determining a pressure in the space and/or the biomass may include a pressure sensor 214, a pressure sensor 214 disposed in the space, a pressure sensor 214 disposed in a cylinder 212 for the press 102, a force transducer to measure force over a known area, an air density sensor to measure air density, or the like. Other embodiments may include similar or equivalent means for determining a pressure.

In various embodiments, a means for determining a temperature in the space and/or the biomass may include a temperature sensor 216, a temperature sensor 216 disposed in the space, a temperature sensor 216 disposed in the horn 218 or in the anvil 112, a thermocouple, a thermistor, a semiconductor-based sensor, or the like. Other embodiments may include similar or equivalent means for determining a temperature

In various embodiments, a means for controlling a temperature and pressure in the space and/or the biomass may include an ultrasonic stack 104, transducer 226, a booster 220, a horn 218, and/or a controller 250, a resistive heater, a combustive heater, a heat pump, a press 102, a compressed air line, an electrically operated switch or valve, an air-powered actuator for a hydraulic cylinder, a controller 250, or the like. Other embodiments may include similar or equivalent means for controlling temperature and pressure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an ultrasonic stack configured to produce ultrasonic vibrations at a first surface;
an anvil comprising a second surface disposed such that the first surface and the second surface define opposite sides of a space for receiving a biomass; and
a press coupled to the ultrasonic stack and the anvil, the press configured to press the ultrasonic stack and the anvil together to compress the space, wherein the compressed space is at least partially unenclosed to permit oil to move out of the biomass.

2. The apparatus of claim 1, further comprising a controller coupled to the ultrasonic stack and the press to control the ultrasonic vibrations and a pressure in the space.

3. The apparatus of claim 2, further comprising a pressure sensor for determining the pressure, the pressure sensor in communication with the controller, wherein the controller is configured to control the press to further compress the space in response to detecting a pressure decrease via the pressure sensor, and to maintain the pressure below a pressure threshold.

4. The apparatus of claim 2, further comprising a temperature sensor for determining a temperature in the space, the temperature sensor in communication with the controller wherein the controller is configured to control the ultrasonic stack to heat the biomass above a first temperature threshold and to maintain the temperature below a second temperature threshold.

5. The apparatus of claim 4, wherein the first temperature threshold is greater than or equal to 80 degrees Celsius and the second temperature threshold is less than or equal to 120 degrees Celsius.

6. The apparatus of claim 1, wherein a duty cycle for the ultrasonic stack is preconfigured based on a desired temperature for the biomass.

7. The apparatus of claim 6, wherein the duty cycle is preconfigured to heat the biomass to the desired temperature without non-ultrasonic heating.

8. The apparatus of claim 1, wherein the first surface and the second surface are flat surfaces of equal size.

9. The apparatus of claim 1, further comprising a silicone coating applied to the first surface and the second surface.

10. The apparatus of claim 1, wherein the first surface and the second surface both have areas in a range from 50 to 150 square centimeters.

11. The apparatus of claim 1, wherein a pressure in the space when the ultrasonic stack and the anvil are pressed together is in a range from 800 to 2200 pounds per square inch.

12. The apparatus of claim 1, wherein the ultrasonic stack comprises a transducer, a booster, and a horn, the horn comprising the first surface.

13. The apparatus of claim 12, wherein the booster and the horn are configured to withstand at least 1500 pounds of force from the press without being damaged.

14. The apparatus of claim 12, wherein the transducer is configured to produce the ultrasonic vibrations with a frequency in a range from 15 to 120 kHz, and with a power of up to 3500 W.

15. The apparatus of claim 1, wherein the press comprises one of:
a hydraulic ram; and
a pneumatic ram.

16. A method comprising:
providing an ultrasonic stack configured to produce ultrasonic vibrations at a first surface;
providing an anvil comprising a second surface disposed such that the first surface and the second surface define opposite sides of a space for receiving a biomass; and
providing a press coupled to the ultrasonic stack and the anvil, the press configured to press the ultrasonic stack and the anvil together to compress the space, wherein the compressed space is at least partially unenclosed to permit oil to move out of the biomass;
placing a biomass in the space; and
using the ultrasonic stack and the press to apply pressure and ultrasonic vibrations to the biomass to extract the oil.

17. The method of claim 16, further comprising:
providing a temperature sensor for determining a temperature of the biomass; and
controlling the ultrasonic stack based on the temperature to heat the biomass above a first temperature threshold and to maintain the temperature below a second temperature threshold.

18. An apparatus comprising:
means for producing ultrasonic vibrations at a first surface;
means for contacting a biomass at a second surface disposed such that the first surface and the second surface define opposite sides of a space for receiving a biomass; and
means for compressing the space between the first surface and the second surface, wherein the compressed space is at least partially unenclosed to permit oil to move out of the biomass.

19. The apparatus of claim 18, further comprising:
means for determining a pressure in the space; and
means for determining a temperature in the space;

20. The apparatus of claim 19, further comprising means for controlling the temperature and pressure in the space.
